(19) United States
(12) Patent Application Publication
(10) Pub. No.: US 2026/0218564 A1
(43) Pub. Date: Jul. 30, 2026

(54) Vacuum Insulated Glass Valve and Method For Sealing the Vacuum Insulated Glass Valve

(71) Applicant: JBG-2 SP. Z O.O., Warszowice (PL)

(72) Inventor: Michal Rutkowski, Gaszowice (PL)

(21) Appl. No.: 19/145,735

(22) PCT Filed: Jan. 25, 2024
(86) PCT No.: PCT/PL2024/050003

§ 371 Date: Jul. 3, 2025

(30) Foreign Application Priority Data
Jan. 27, 2023 (PL) P.443615

(51) Int. Cl. E06B 3/677

(52) U.S. Cl. CPC E06B 3/6775

(57) ABSTRACT

A vacuum insulated glass valve arranged in glass sheets of the vacuum insulated glass is described where the depth of each recess in a corresponding glass sheet is at least ⅓ of the thickness of the corresponding glass sheet with each end of a sleeve member arranged in an internal channel between the recesses extending to at least ¼ of the depth of the corresponding recess of the corresponding glass sheet. The sleeve member is fixed using a binder, which is arranged annularly truncated around a part of the sleeve member protruding between the glass sheets. A method for sealing the valve of the vacuum insulated glass completely fills the recess of the glass sheet with a curable filler material.

### FIELD OF THE DISCLOSURE

The present invention relates to a vacuum insulated glass valve and a method for sealing the vacuum insulated glass valve.

### BACKGROUND

In the prior art, valves are known to protrude above the glass sheet or form a recess in the glass sheet.

WO 2020/255032 A1 discloses a solution in which the sealing tube or sealing material is arranged within the VIG unit (vacuum insulated glass unit), thereby potentially eliminating the need for a protective cap and allowing greater freedom in handling, frame design, VIG hybrid construction, lamination and the like. The sealing tube can be disarranged into an inner region within the recessed substrate pocket in at least some embodiments. The VIG unit does not have any protruding pump-out tube or the like.

U.S. Pat. No. 5,657,607A discloses a thermally insulating glass sheet comprising two spaced apart sheets of glass enclosing a low-pressure space and interconnected by a peripheral joint of fused solder glass and an array of pillars and a pump-out tube for providing communication between the low-pressure space and the exterior of the insulating glass sheet during the formation of the low-pressure space. Each pillar comprises a preformed core of a selected geometry and material and an intermediate glass coating for bonding at least in the regions between the pre-formed core and the glass sheet. Preferably, the preformed core has a spherical shape and is completely coated with intermediate bonding glass. The preformed core serves to separate the glass sheets during the heating process in the production of the glass when the intermediate bonding glass is in the molten state, and the intermediate bonding glass serves as a mechanical joint to support the glass sheets after solidification. Furthermore, to increase the strength of the mechanical joint, a thin layer of intermediate-bonding glass can be arranged close to the pillars on the glass sheets, thus increasing the wetting region of the intermediate-bonding glass coating of the pillar.

### SUMMARY

A disadvantage of the above solutions is their structural complexity. In addition, the possibility of damage to the valve protruding above the glass sheet or, in the case of a recess, the possible lack of tightness and the lack of a uniformly even surface. In addition, the above solutions are based on glazing that has truncated corners that affect the lack of aesthetics and tightness.

It is an object of the invention to provide a vacuum insulated glass valve that eliminates the disadvantages of the prior art, ensuring that the sealed valve with its filler does not protrude above the surface of the glass sheet, nor does it form a recess, creating a smooth surface when sealed. In addition, solutions according to the invention are structurally simplified, thus easy and inexpensive to manufacture.

In the vacuum insulated glass valve described herein, the depth of each recess is at least ⅓ of the thickness of the corresponding glass sheet. Each end of the sleeve member (e.g., located between the glass sheets) extends correspondingly to at least ¼ of the depth of the corresponding recess of the corresponding glass sheet, and the sleeve member is fixed using a binder arranged annularly truncated around the protruding part of the sleeve member.

Preferably, in some implementations, irrespective of the thickness of the glass sheet, the depth of the recess remains the same such that the ratio of the depth of the recess to the thickness of the glass sheet changes as the thickness of the glass sheet increases.

Preferably, in some implementations, the sleeve member is positioned so that it does not touch the bottom of the recess in the glass sheet.

Preferably, in some implementations, the sleeve member is a glass tube.

Preferably, in some implementations, the sleeve member has non-machined surfaces.

Preferably, in some implementations, the glass sheet is tempered glass.

Preferably, in some implementations, the glass sheet is a non-tempered float glass sheet.

Preferably, in some implementations, the binder is a glass frit.

Preferably, in some implementations, the inner channel is arranged at the central point of the recess.

Preferably, in some implementations, the inner channel is of a diameter larger than the outer diameter of the sleeve member.

Preferably, in some implementations, the recesses are coaxially aligned with each other.

Preferably, in some implementations, the vacuum insulated glass valve has a seal.

Preferably, in some implementations, the seal including the filler of the recess in the glass sheet lies on the same plane with the surrounding surface of the glass sheet.

A method for sealing the vacuum insulated glass valve includes completely filling the recess of the glass sheet with a curable filler material.

Preferably, the method in some implementations results in the seal including the filler of the recess in the glass sheet being on the same plane with the surrounding surface of the glass sheet.

Preferably, the method in some implementations uses a curable filler material that is a resin or an adhesive.

Variations in these and other aspects will be described in additional detail hereafter.

### BRIEF DESCRIPTION OF THE DRAWING

Embodiments of the object of the present invention are shown in the drawing, wherein the individual figures are described below.

FIG. 1 is a cross-sectional view of an embodiment of a vacuum insulated glass with the arrangement of two glass sheets before the placement of the vacuum insulated glass valve according to the teachings herein.

FIG. 2 is a cross-sectional view of an embodiment of a vacuum insulated glass valve with the vacuum insulated glass valve according to the teachings herein positioned and binder fixed.

FIG. 3 is a cross-sectional view of an embodiment of a vacuum insulated glass valve with a positioned, binder fixed and sealed vacuum insulated glass valve according to the teachings herein.

FIG. 4 is a cross-sectional view of an embodiment of a vacuum insulated glass valve with an arranged, binder fixed and sealed vacuum insulated glass valve filled with fully cured filler material to obtain a flat surface according to the teachings herein.

FIG. 5 is a cross-sectional view of an embodiment of the vacuum insulated glass valve according to the teachings herein.

FIG. 6 is a cross-sectional view of an embodiment of a vacuum insulated glass with the arrangement of two glass sheets before the placement of the vacuum insulated glass valve according to the teachings herein.

FIG. 7 is a cross-sectional view of an embodiment of a vacuum insulated glass valve with the vacuum insulated glass valve according to the teachings herein positioned and binder fixed.

FIG. 8 is a cross-sectional view of an embodiment of a vacuum insulated glass valve with an arranged, fixed binder and sealed vacuum insulated glass valve according to the teachings herein.

FIG. 9 is a cross-sectional view of an embodiment of a vacuum insulated glass valve with arranged, fixed binder and sealed vacuum insulated glass valve filled with fully cured filler material to obtain a flat surface according to the teachings herein.

FIG. 10 is a cross-sectional view of an embodiment of the vacuum insulated glass with the arrangement of the two glass sheets before the placement of the vacuum insulated glass valve according to the teachings herein.

FIG. 11 is a cross-sectional view of an embodiment of a vacuum insulated glass valve with the vacuum insulated glass valve according to the teachings herein positioned and binder fixed.

FIG. 12 is a cross-sectional view of an embodiment of a vacuum insulated glass valve with a positioned, binder fixed and sealed vacuum insulated glass valve according to the teachings herein.

FIG. 13 is a cross-sectional view of an embodiment of a vacuum insulated glass valve with an arranged, fixed binder and sealed vacuum insulated glass valve filled with a fully cured filler material to obtain a flat surface according to the teachings herein.

### DETAILED DESCRIPTION

### Example 1

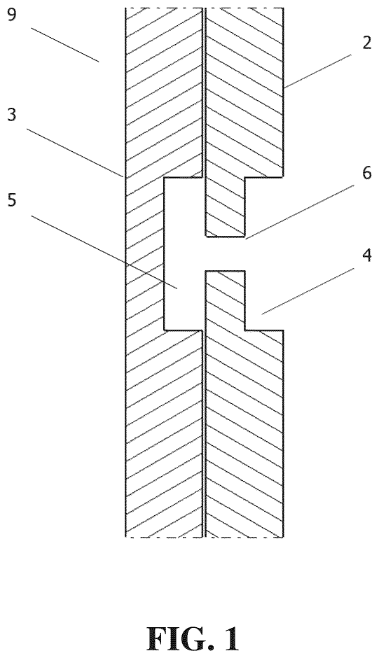

FIG. 1 shows a first variant of an embodiment of the vacuum insulated glass 9 according to the teachings herein. The figure shows the arrangement of two glass sheets 2, 3 with a thickness of 4 mm each, relative to each other before the placement of valve 1 of the vacuum insulated glass 9. In this embodiment, glass sheets 2, 3 are tempered glass. Each glass sheet 2, 3 of the vacuum insulated glass sheet 9 has a recess 4, 5 in its surface in the form of a sub-milling. The recesses 4, 5 in the form of a sub-milling are made to a depth of at least ⅓ of, here equal to half, the thickness of each glass sheet 2, 3 and are aligned with each other and coaxially aligned. In addition, an internal channel 6 is provided at the central point of recess 4 in the form of a sub-milling. The recess 5 in the form of a sub-milling made in the glass sheet 3 forms a chamber, which provides space for the sleeve member and the binder surrounding the sleeve member.

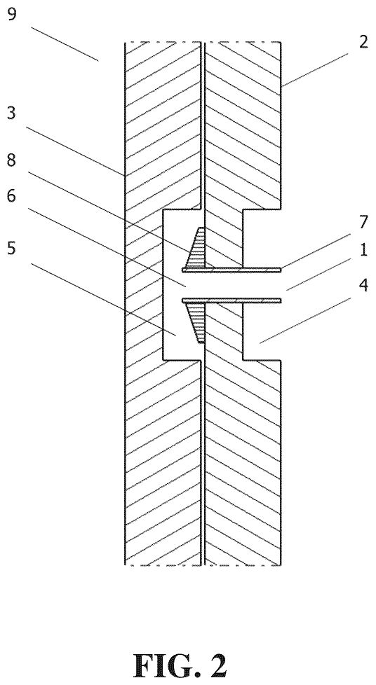

FIG. 2 shows the first variant of an embodiment of valve 1 of the vacuum insulated glass 9 with valve 1 of the vacuum insulated glass 9 positioned and fixed. At the central point of the recess 4 in the glass sheet 2, an internal channel 6 is made in the form of a sub-milling, with a diameter slightly larger than the diameter of sleeve member 7. The sleeve member 7 in the form of a glass tube is arranged in the internal channel 6 such that each end is located between the glass sheets. The sleeve member 7 in the form of a glass tube is fixed with a binder 8, which in this embodiment is glass frit. The sleeve member 7 in the form of a glass tube extends to at least ¼, here ½, the depth of the recess 5 in the glass sheet 3. The sleeve member 7 in the form of a glass tube is fixed using a binder 8, which is arranged annularly truncated around the protruding part of the sleeve member 7 in the form of a glass tube.

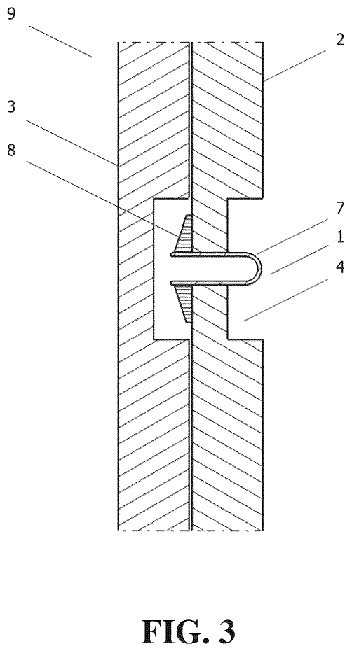

FIG. 3 shows the first variant of an embodiment of the valve 1 of the vacuum insulated glass 9 with an arranged, fixed binder 8 and sealed valve 1 of the vacuum insulated glass 9. After extracting the air and creating a vacuum between the glass sheets 2, 3, one end of the sleeve member 7 in the form of a glass tube, arranged in the recess 4 in the form of a sub-milling of the glass sheet 2, is sealed.

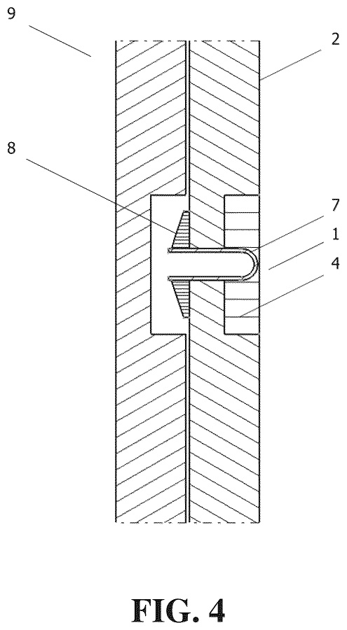

FIG. 4 shows the first variant of an embodiment of the valve 1 of the vacuum insulated glass 9 with a positioned, fixed binder 8 and sealed valve 1 of the vacuum insulated glass 9. The sealed end of the sleeve member 7 in the form of a glass tube, arranged in the recess 4 in the form of a sub-milling of the glass sheet 2, is completely filled with a curable filler material to obtain a flat surface. This means that the seal including the filler of the recess 4 in the form of a sub-milling in the glass sheet 2 is on the same plane as the surrounding surface of the glass sheet 2. In this example, the curable filler material is a resin.

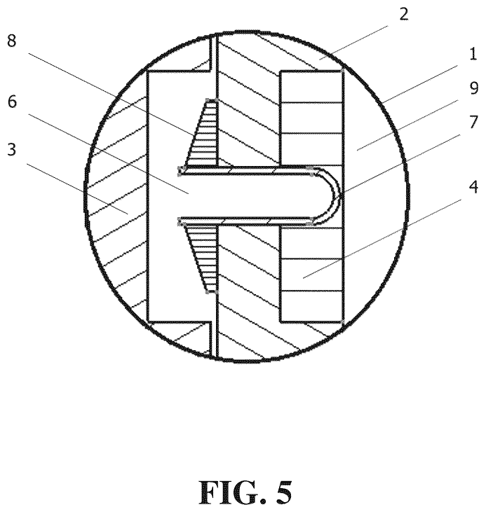

The method according to the invention will be explained in more detail based on an example embodiment shown in FIG. 5.

FIG. 5 shows an embodiment of the valve 1 of the vacuum insulated glass 9 with an arranged, fixed binder 8 and fully formed valve 1 of the vacuum insulated glass 9. In the inner channel 6 made in the glass sheet 2, 3, a sleeve member 7 in the form of a glass tube has been arranged, which has mechanically untrimmed surfaces. The binder 8 is therefore arranged on the non-machined surfaces, which results in its adhesion without leaks. In addition, the sleeve member 7 in the form of a glass tube, which is arranged in the recess 4 in the form of a sub-milling of the glass sheet 2, is completely filled with a curable filler material. The curable filter material can be either glue or resin. This results in a flat, weather-resistant surface.

### Example 2

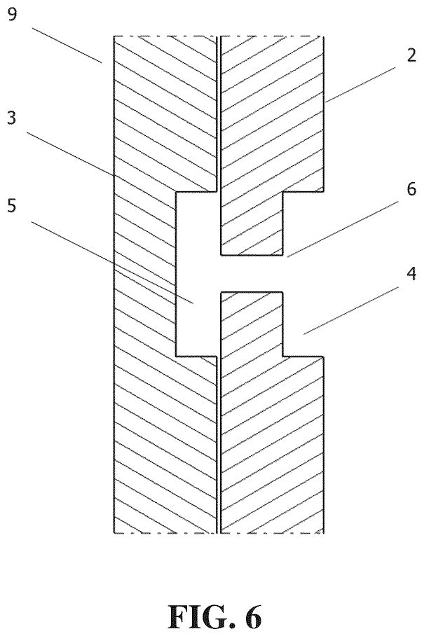

FIG. 6 shows a second variant of an embodiment of the vacuum insulated glass 9 according to the teachings herein. The figure shows two glass sheets 2, 3 with a thickness of 5 mm each arranged relative to each other before the placement of the valve 1 of the vacuum insulated glass 9. In this embodiment, the glass sheets 2, 3 are tempered glass. Each glass sheet 2, 3 of the vacuum insulated glass sheet 9 has, in its surface, a recess 4, 5 in the form of a sub-milling. The recesses 4, 5 in the form of a sub-milling are made to a depth of at least ⅓, here ⅖. of the thickness of each glass sheet 2, 3 and are aligned and concentric with one another. In addition, an internal channel 6 is provided at the center of the recess 4 in the form of a sub-milling. The recess 5 in the form of a sub-milling made in the glass sheet 3 forms a chamber, which provides space for the sleeve member and the binder surrounding the sleeve member.

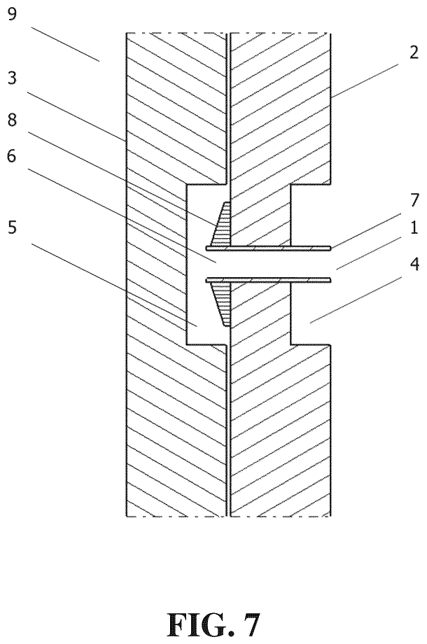

FIG. 7 shows a second variant of an embodiment of the valve 1 of the vacuum insulated glass 9 with the valve 1 of the vacuum insulated glass 9 positioned and fixed. At the central point of the recess 4 in the glass sheet 2, an internal channel 6 is made in the form of a sub-milling with a diameter slightly larger than the diameter of the sleeve member 7. The sleeve member 7 in the form of a glass tube is arranged in the internal channel 6. The sleeve member 7 in the form of a glass tube is fixed with a binder 8, which in this embodiment is glass frit. The sleeve member 7 in the form of a glass tube extends to at least ¼, here ½, the depth of the recess 5 in the glass sheet 3. The sleeve member 7 in the form of a glass tube is fixed using a binder 8. The binder 8 is arranged annularly truncated around the protruding part of the sleeve member 7 in the form of a glass tube.

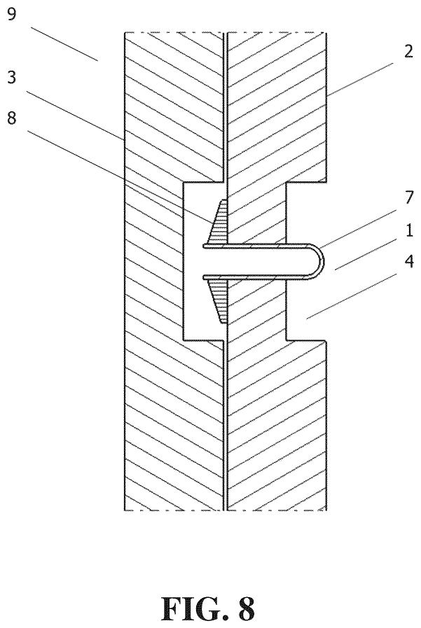

FIG. 8 shows a second variant of an embodiment of the valve 1 of the vacuum insulated glass 9 with an arranged, fixed binder 8 and sealed valve 1 of the vacuum insulated glass 9 according to the teachings herein. After extracting the air and creating a vacuum between the glass sheets 2, 3, one end of the sleeve member 7 in the form of a glass tube arranged in the recess 4 in the form of a sub-milling of the glass sheet 2 is sealed.

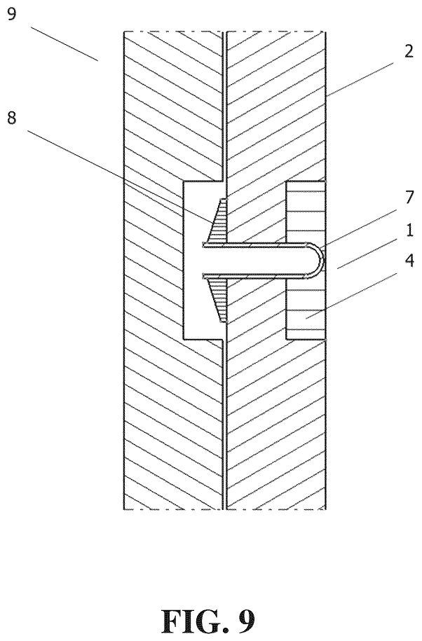

FIG. 9 shows a second variant of an embodiment of the valve 1 of the vacuum insulated glass 9 with a positioned, fixed binder 8 and sealed valve 1 of the vacuum insulated glass 9. The sealed end of the sleeve member 7 in the form of a glass tube, which is arranged in the recess 4 in the form of a sub-milling of the glass sheet 2, is completely filled with a curable filler material to obtain a flat surface. This means that the seal including the filler of the recess 4 in the form of a sub-milling in the glass sheet 2 is on the same plane as the surrounding surface of the glass sheet 2. In this example, the curable filler material is a resin.

### Example 3

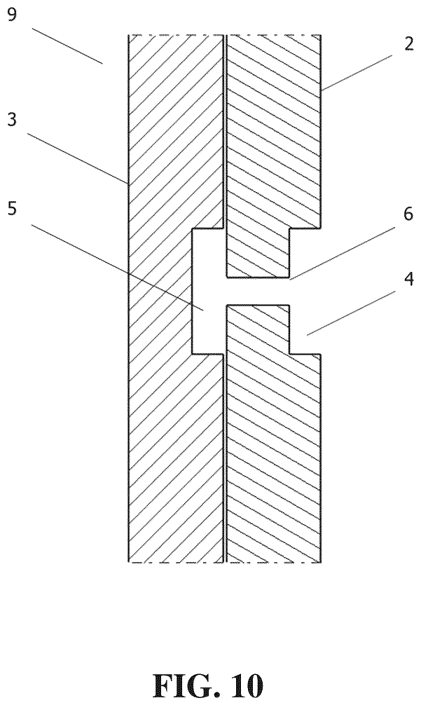

FIG. 10 shows a third variant of an embodiment of the vacuum insulated glass 9 according to the teachings herein. The figure shows two glass sheets 2, 3 with a thickness of 6 mm each arranged relative to each other before the placement of the valve 1 of the vacuum insulated glass 9. In this embodiment, the glass sheets 2, 3 are tempered glass. Each glass sheet 2, 3 of the vacuum insulated glass sheet 9 has in its surface a recess 4, 5 in the form of a sub-milling. The recesses 4, 5 in the form of a sub-milling are made to a depth of ⅓ of the thickness of each glass sheet 2, 3 and are aligned and concentric with one another. In addition, an internal channel 6 is provided in the middle point of the recess 4 in the form of a sub-milling. The recess 5 in the form of a sub-milling made in the glass sheet 3 forms a chamber that provides space for the sleeve member and the binder surrounding the sleeve member.

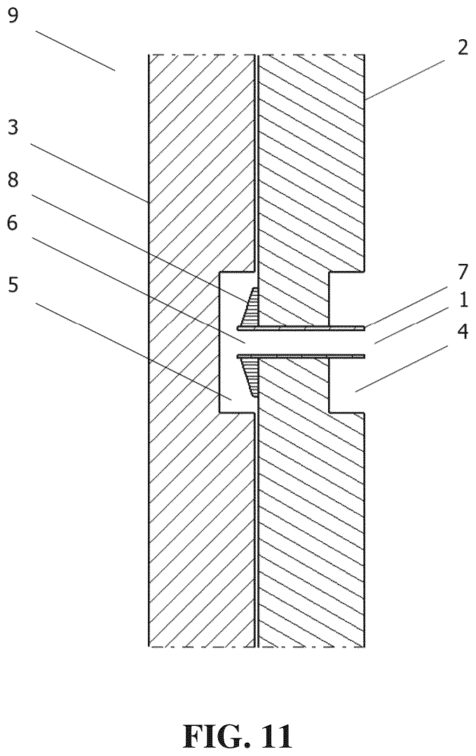

FIG. 11 shows a third variant of an embodiment of the valve 1 of the vacuum insulated glass 9 with the valve 1 of the vacuum insulated glass 9 positioned and fixed. At the central point of the recess 4 in the glass sheet 2, an internal channel 6 is made in the form of a sub-milling having a diameter slightly larger than the diameter of the sleeve member 7. The sleeve member 7 in the form of a glass tube is arranged in the internal channel 6. The sleeve member 7 in the form of a glass tube is fixed with a binder 8, which in this embodiment is glass frit. The sleeve member 7 in the form of a glass tube extends to at least ¼, here ½, the depth of the recess 5 in the glass sheet 3. The sleeve member 7 in the form of a glass tube is fixed using a binder 8. The binder 8 is arranged annularly truncated around the protruding part of the sleeve member 7 in the form of a glass tube.

As is clear from the above examples, irrespective of the thickness of the glass sheet, the depth of the corresponding recess remains the same (unchanged) such that the ratio of the depth of the recess to the thickness of the glass sheet changes as the thickness of the glass sheet increases.

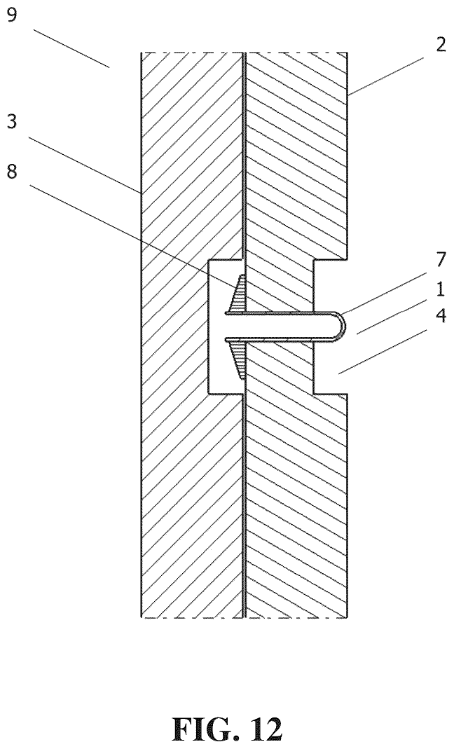

FIG. 12 shows a third variant of an embodiment of the valve 1 of the vacuum insulated glass 9 with an arranged, fixed binder 8 and sealed valve 1 of the vacuum insulated glass 9. After extracting the air and creating a vacuum between the glass sheets 2, 3, one end of the sleeve member 7 in the form of a glass tube, which is arranged in the recess 4 in the form of a sub-milling of the glass sheet 2, is sealed.

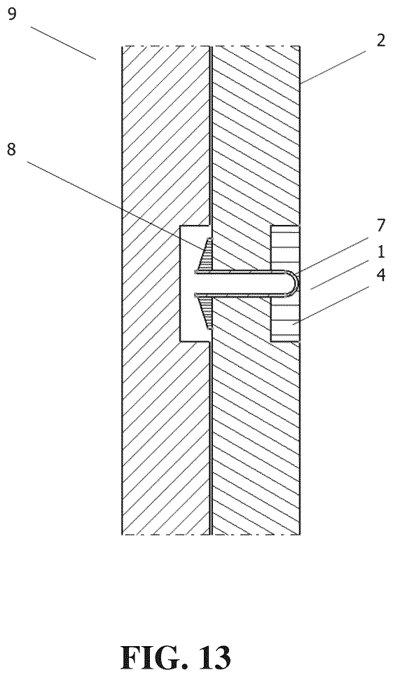

FIG. 13 shows a third variant of an embodiment of the valve 1 of the vacuum insulated glass 9 with a positioned, fixed binder 8 and sealed valve 1 of the vacuum insulated glass 9. The sealed end of the sleeve member 7 in the form of a glass tube, which is arranged in the recess 4 in the form of a sub-milling of the glass sheet 2, is completely filled with a curable filler material to obtain a flat surface. This means that the seal including the filler of the recess 4 in the form of a sub-milling in the glass sheet 2 is on the same plane as the surface surrounding the glass sheet 2. In this example, the curable filler material is a resin.

In a method according to the teachings herein, for each of the glass sheets 2, 3, a recess 4, 5 and an inner channel 6 are correspondingly formed between these recesses 4, 5. A sleeve member 7 is arranged in the inner channel 6, the seal of which is formed by thermal melting of its end. The recess 4 of the glass sheet 2 is filled with a fully curable filler material, which in the example embodiment is a resin. Accordingly, the seal including the filler of the recess 4 in the glass sheet 2 is on the same plane as the surface surrounding the glass sheet 2.

Although the examples above describe the glass sheets 2, 3 as tempered glass, each glass sheet may be a non-tempered float glass sheet.

The following is a list of reference numbers used in this specification and in the drawing figures.
1 vacuum insulated glass valve
2 glass sheet
3 glass sheet
4 recess
5 recess
6 internal channel
7 sleeve member
8 binder
9 vacuum insulated glass

1. A valve of a vacuum insulated glass arranged in glass sheets of the vacuum insulated glass, wherein:
each of the glass sheets comprises a recess,
a sleeve member is arranged in an internal channel between the recesses,
a depth of each recess is at least ⅓ of a thickness of a corresponding glass sheet,
each end of the sleeve member located between the glass sheets extends to at least ¼ of a depth of the recess of the corresponding glass sheet,
the sleeve member is fixed using a binder, and
the binder is arranged annularly truncated around a part of the sleeve member protruding between the glass sheets.

2. The valve of the vacuum insulated glass according to claim 1, wherein, irrespective of the thickness of the corresponding glass sheet, the depth of each recess remains unchanged such that as the thickness of the corresponding glass sheet increases, a ratio of the depth of the recess to the thickness of the corresponding glass sheet changes.

3. (canceled)

4. (canceled)

5. The valve of the vacuum insulated glass according to claim 1, wherein the sleeve member is a glass tube that has non-machined surfaces.

6. (canceled)

7. The valve of the vacuum insulated glass-according to claim 1, wherein each of the glass sheets is a non-tempered float glass sheet.

8. The valve of the vacuum insulated glass according to claim 1, wherein the binder is a glass frit.

9.-16. (canceled)
